(19) United States
(12) Patent Application Publication
(10) Pub. No.: US 2020/0031632 A1
(43) Pub. Date: Jan. 30, 2020

(54) HOOK DEVICE AND CRANE

(71) Applicant: SUMITOMO HEAVY INDUSTRIES CONSTRUCTION CRANES CO., LTD., Tokyo (JP)

(72) Inventor: Akira Hanahara, Aichi (JP)

(21) Appl. No.: 16/523,557

(22) Filed: Jul. 26, 2019

(30) Foreign Application Priority Data
Jul. 30, 2018 (JP) 2018-142844

(51) Int. Cl. B66C 1/34; B66D 3/06

(52) U.S. Cl. CPC B66C 1/34; B66D 3/06

(57) ABSTRACT

A hook device includes a central shaft which extends in a first direction, and a first locking portion and a second locking portion which are disposed such that the central shaft is interposed therebetween, in a second direction orthogonal to the first direction. The first locking portion and the second locking portion are connected to the central shaft in a state where the first locking portion and the second locking portion are not rotatable independently around an axis extending in the first direction and are rotatable around an axis extending in a third direction different from the first direction and the second direction.

### RELATED APPLICATIONS

The content of Japanese Patent Application No. 2018-142844, on the basis of which priority benefits are claimed in an accompanying application data sheet, is in its entirety incorporated herein by reference.

### BACKGROUND

### Technical Field

Certain embodiment of the present invention relates to a crane on which the hook device is mounted.

### Description of Related Art

In the related art, a hook block combining a plurality of hooks is used in a crane. The hook block including the plurality of hooks has an advantage that it can be used for a wide range of applications such as lifting a low load cargo by some hooks or lifting a high load cargo by all hooks.

As an example of the hook block, a hook block including a sheave housing which is connected to a wire suspended from a boom of a crane, a pair of plates which is supported by the sheave housing so as to be rotatable around a horizontal axis, and two dual-key hooks which are supported by the pair of plates so as to be rotatable around the horizontal axis and a vertical axis is disclosed in the related art.

### SUMMARY

According to an embodiment of the present invention, there is provided a hook device including: a central shaft which extends in a first direction; and a first locking portion and a second locking portion which are disposed such that the central shaft is interposed therebetween, in a second direction orthogonal to the first direction, in which the first locking portion and the second locking portion are connected to the central shaft in a state where the first locking portion and the second locking portion are not rotatable independently around an axis extending in the first direction and are rotatable around an axis extending in a third direction different from the first direction and the second direction.

### BRIEF DESCRIPTION OF THE DRAWINGS

FIG. 1 is a side view of a crawler crane according to the present embodiment.

FIG. 2 is a front view of a hook block according to the present embodiment.

FIG. 3 is a side view of the hook block of FIG. 2.

FIG. 4 is a view showing a state where a cargo is hung on both a first single-hook and a second single-hook.

FIG. 5 is a view showing a state where the cargo is hung on only the first single-hook.

FIG. 6 is a front view and side view of the hook block according to a modification example.

FIG. 7 is a front view of the hook block according to the modification example.

### DETAILED DESCRIPTION

In the related art, it is assumed that a cargo is hung on one dual-key hook. In this case, it is necessary to perform a hooking operation such that a center of gravity of the cargo is positioned immediately below a shaft portion of the dual-key hook. However, a high level of technology is required so as to appropriately adjust a relative position between the dual-key hook and the center of gravity of the cargo, and thus, the adjusting the relative position is particularly difficult to be used in a field where personal and time limits are large.

In addition, if the cargo is lifted in a state where the position of the center of gravity is shifted from immediately below the shaft portion of the dual-key hook, a bending load acts on the dual-key hook, and thus, the dual-key hook and a thrust bearing are strongly rubbed. As a result, a smooth rotation of the dual-key hook is hindered, and thus, there is a possibility that the shaft of the dual-key hook cannot withstand the bending load and thus, the shaft of the dual-key hook is broken.

It is desirable to provide a hook device having a plurality of locking portions and a structure capable of automatically adjusting a relative position between the hook device and the center of gravity of the cargo.

According to the present invention, it is possible to automatically adjust a relative position between a hook device and a center of gravity of a cargo in the hook device including a plurality of locking portions. In addition, objects, configurations, and effects except for the above-described those are clarified in description of the following embodiment.

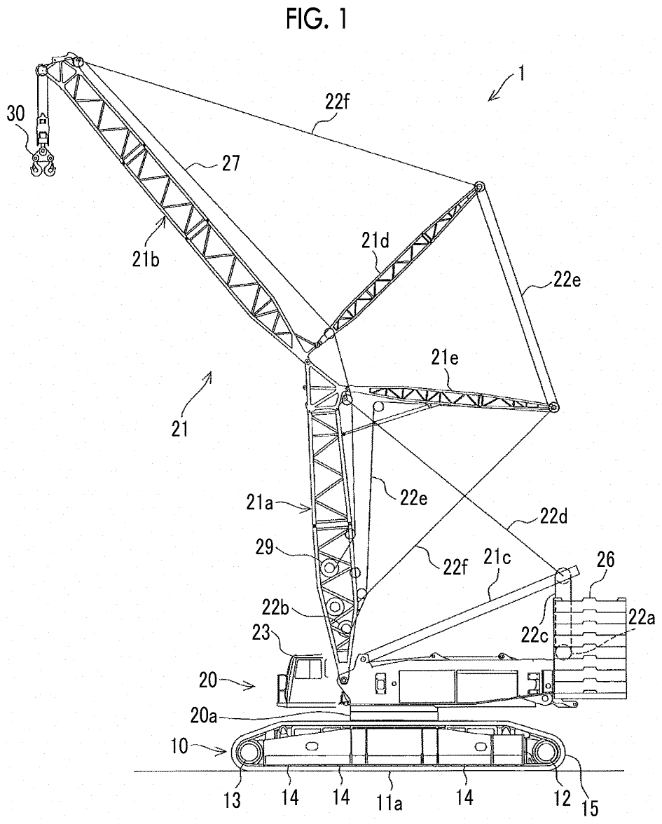

Hereinafter, an embodiment of the present invention will be described with reference to the drawings. FIG. 1 is a side view of a crawler crane 1 which is a representative example of a crane. In addition, in descriptions of FIG. 1, unless otherwise specified, the front, rear, left, and right are based on a viewpoint of an operator who rides on the crawler crane 1 and operates the crawler crane 1.

The crawler crane 1 includes a lower traveling body (crawler) 10 which can travel and an upper turning body 20 which is turnably supported by the lower traveling body 10 via a turning bearing 20a. The lower traveling body 10 includes a pair of endless tracks 11a and 11b (in FIG. 1, the endless track 11b is not shown) on both ends in a right-left direction. The upper turning body 20 supports a boom 21, a cabin 23, an engine (not shown), and a counterweight 26.

Each of the endless tracks 11a and 11b1 mainly includes a drive wheel 12 which is disposed on a rear end, a driven wheel 13 which is disposed on a front end, a plurality of rollers 14 which are disposed between the drive wheel 12 and the driven wheel 13, and a shoe 15 which is wound around the drive wheel 12, the driven wheel 13, and the rollers 14. A driving force of the engine is transmitted to the drive wheels 12 and the endless tracks 11a and 11b are rotated, and thus, the lower traveling body 10 travels. In addition, instead of the lower traveling body 10 having the endless tracks 11a and 11b, the lower traveling body 10 may be a wheeled type lower traveling body.

The boom 21 includes a tower boom 21a, a tower jib 21b, a mast 21c, a front strut 21d, and a rear strut 21e. A proximal end of the tower boom 21a is supported by a front end of the upper turning body 20 and extends forward and upward of the upper turning body 20. The tower jib 21b is supported by a distal end of the tower boom 21a and extends forward and upward of the upper turning body 20.

The mast 21c is supported by the upper turning body 20 near a connection position between the tower boom 21a and the mast 21c and extends rearward and upward of the upper turning body 20. The front strut 21d and the rear strut 21e are provided near a connection portion between the tower boom 21a and the tower jib 21b. In addition, a length of each of the tower boom 21a and the tower jib 21b can be appropriately changed. Moreover, a derricking motion of the boom 21 is performed by winches 22a and 22b.

The winch 22a is supported by the upper turning body 20. A wire 22c extending from the winch 22a is connected to a distal end of the mast 21c. In addition, distal ends of the mast 21c and the tower boom 21a are connected by a wire 22d. In addition, the winch 22a lets out the wire 22c, and thus, the tower boom 21a is lowered. The winch 22a winds the wire 22c, and thus, the tower boom 21a is raised.

The winch 22b is disposed on a proximal end portion of the tower boom 21a. The wires 22e and 22f extending from the winch 22b are connected to a distal end of the tower jib 21b via a distal end of the rear strut 21e and a distal end of the front strut 21d. In addition, the winch 22b lets out the wires 22e and 22f, and thus, the boom 21 is lowered. The winch 22b winds the wires 22e and 22f, and thus, the boom 21 is raised. That is, the tower boom 21a and the tower jib 21b are supported by the upper turning body 20 in a state where derricking motions of the tower boom 21a and the tower jib 21b can be performed.

The boom 21 includes a wire 27, a winch 29, and a hook block (hook device) 30. The wire 27 extends along the tower boom 21a and tower jib 21b from the winch 29 and is suspended from the distal end of the tower jib 21b. The winch 29 is provided near the proximal end of the tower boom 21a to let out or wind the wire 27. The hook block 30 is hung on the wire 27 suspended from the distal end of the tower jib 21b.

The winch 29 lets out the wire 27, and thus, the hook block 30 is lowered. In addition, the winch 29 winds the wire 27, and thus, the hook block 30 is raised. However, the tower jib 21b may be omitted such that the hook block 30 is hung on the wire 27 suspended from the distal end of the tower boom 21a.

In the cabin 23, an internal space on which an operator who operating the crawler crane 1 rides is formed. An operation device (steering, pedal, lever, switch, or the like) is disposed in the internal space of the cabin 23. The operation device receives an operation of the operator to travel the lower traveling body 10, turn the upper turning body 20, performs the derricking motion of the boom 21, or raise or lower the hook block 30 (that is, cause the winch 29 to let out or wind the wire 27). That is, the operator who rides on the cabin 23 operates the operation device, and thus, the crawler crane 1 is operated.

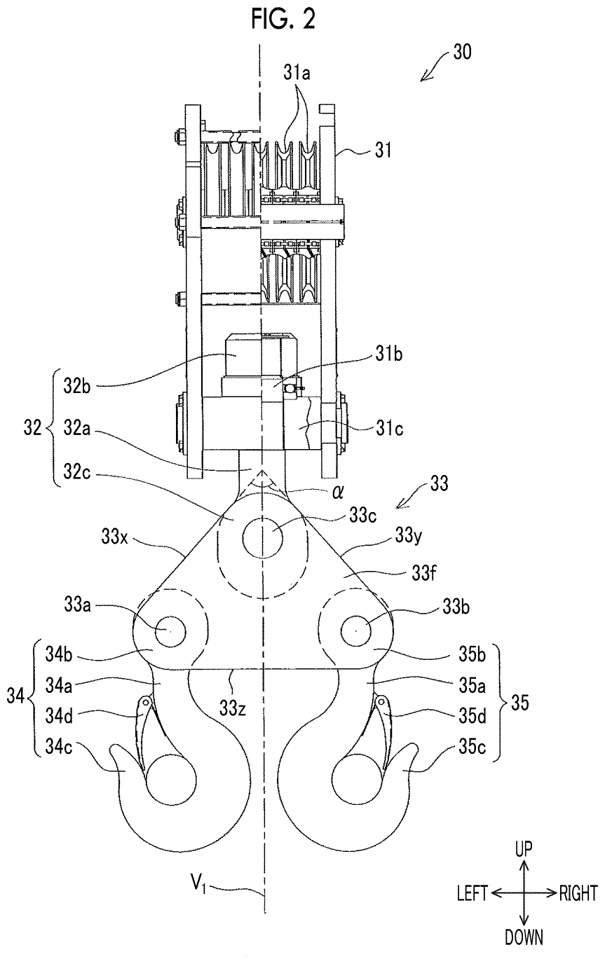

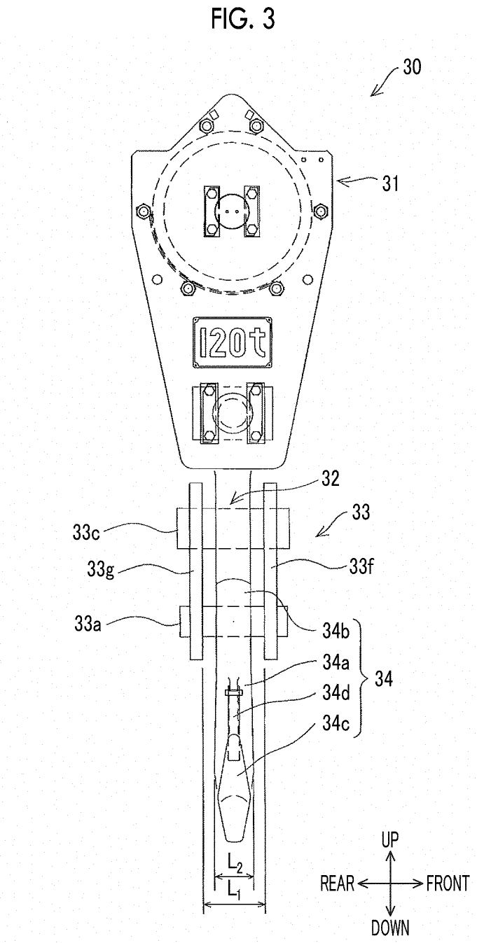

Next, details of the hook block 30 according to the present embodiment will be described with reference to FIGS. 2 and 3. FIG. 2 is a front view of the hook block 30 and FIG. 3 is a side view of the hook block 30. Moreover, in the following descriptions, upper and lower sides of a paper surface of FIG. 2 are defined as an upward-downward direction (first direction), right and left of the paper surface of FIG. 2 are defined as a right-left direction (second direction), and a direction orthogonal to the paper surface of FIG. 2 is defined as a forward-rearward direction (third direction). In a state where the hook block 30 is hung on the wire 27, the upward-downward direction coincides with a vertical direction, and the right-left direction coincides with a horizontal direction. In addition, the upward-downward direction, the right-left direction, and the forward-rearward direction are orthogonal to each other. However, the third direction is not limited to the direction orthogonal to the first direction and the second direction, and may be a direction different from the first direction and the second direction.

The hook block 30 mainly includes a sheave block 31, a central shaft 32, a connection member 33, a first single-hook 34, and a second single-hook 35.

The sheave block 31 includes a plurality of sheaves 31a around which the wire 27 suspended from the distal end of the boom 21 is wound, a thrust bearing 31b which rotatably supports the central shaft 32 around an axis extending in the upward-downward direction, and a trunnion 31c which fixes the thrust bearing 31b to the sheave block 31.

The central shaft 32 includes a columnar small-diameter portion 32a, a large-diameter portion 32b which is provided on one end (upper end) of the small-diameter portion 32a, and an eye end 32c which is provided on the other end (lower end) of the small-diameter portion 32a. An inner diameter of the thrust bearing 31b is larger than a diameter of the small-diameter portion 32a and is smaller than a diameter of the large-diameter portion 32b. That is, if the small-diameter portion 32a is inserted into the thrust bearing 31b, an end face of the large-diameter portion 32b is supported by the thrust bearing 31b. The eye end 32c is opened below a lower end of the sheave block 31 in the forward-rearward direction.

The connection member 33 includes a first shaft 33a, a second shaft 33b, and a third shaft 33c which respectively extend in the forward-rearward direction, and a pair of support plates 33f and 33g which supports the first shaft 33a, the second shaft 33b, and the third shaft 33c. The connection member 33 is a member which connects the central shaft 32, the first single-hook 34, and the second single-hook 35 to each other.

The first shaft 33a and the second shaft 33b are disposed at positions separated from each other in the right-left direction. More specifically, the first shaft 33a and the second shaft 33b are disposed on sides opposite to each other such that the third shaft 33c is interposed therebetween, in the right-left direction. The first shaft 33a and the second shaft 33b are disposed at a position separated from the third shaft 33c in the upward-downward direction. That is, when the connection member 33 is viewed in the forward-rearward direction, a triangle which connects centers of the first shaft 33a, the second shaft 33b, and the third shaft 33c is an isosceles triangle with a central position of the third shaft 33c as an apex angle. In addition, preferably, the apex angle is 90° or less.

The pair of support plates 33f and 33g is disposed to be separated from each other in the forward-rearward direction by a distance L₁. In addition, the support plate 33f supports one end of each of the first shaft 33a, the second shaft 33b, and the third shaft 33c, and the support plate 33g supports the other end of each of the first shaft 33a, the second shaft 33b, and the third shaft 33c. That is, the first shaft 33a, the second shaft 33b, and the third shaft 33c are disposed between the pair of support plates 33f and 33g.

When viewed in the forward-rearward direction, an appearance of each of the support plates 33f and 33g exhibits an isosceles triangle in which each vertex is chamfered. More specifically, when the support plates 33f and 33g are viewed in the forward-rearward direction, each of the support plates 33f and 33g includes a first side 33x along an imaginary line connecting the centers of the first shaft 33a and the third shaft 33c to each other, a second side 33y along an imaginary line connecting the centers of the second shaft 33b and the third shaft 33c to each other, and a third side 33z along an imaginary line connecting the first shaft 33a and the second shaft 33b to each other. An angle α between the first side 33x and the second side 33y is set to 90° or less.

The first single-hook 34 includes a shaft portion 34a, an eye end 34b which is provided on one end (upper end) of the shaft portion 34a, a locking portion (first locking portion) 34c which is curved from the other end (lower end) of the shaft portion 34a and extends upward, and a stopper 34d which prevents dropping of the wire hooked to the locking portion 34c. The second single-hook 35 has the same shape as that of the first single-hook 34, and includes a shaft portion 35a, an eye end 35b, a locking portion (second locking portion) 35c, and a stopper 35d. Each of the eye end 34b and 35b is opened in the forward-rearward direction.

Each of the first single-hook 34 and the second single-hook 35 is a so-called “single-key hook” having only one locking portion. In addition, when viewed in the right-left direction, a thickness dimension L₂ of each of the first single-hook 34 and the second single-hook 35 is set smaller (L₁>L₂) than the separation distance L₁ of the pair of support plates 33f and 33g. In addition, for example, each of the first single-hook 34 and the second single-hook 35 can hang a cargo of about 80 tons. That is, the entire hook block 30 has the same performance as that of a dual-key hook capable of hanging a cargo of about 160 tons.

The first shaft 33a is inserted into the eye end 34b of the first single-hook 34, the second shaft 33b is inserted into the eye end 35b of the second single-hook 35, and the third shaft 33c is inserted into the eye end 32c of the central shaft 32. That is, the central shaft 32, the first single-hook 34, and the second single-hook 35 are indirectly connected to each other via the connection member 33.

In addition, the first single-hook 34 and the second single-hook 35 are disposed on sides opposite to each other such that the central shaft 32 is interposed therebetween, in the right-left direction. In other words, the central shaft 32 is disposed between the first single-hook 34 and the second single-hook 35 in the right-left direction. In addition, the first single-hook 34 and the second single-hook 35 (more specifically, locking portions 34c and 35c) are separated from each other in the right-left direction.

Moreover, the first single-hook 34 and the second single-hook 35 are connected to the connection member 33 in a state where the locking portions 34c and 35c facing outward. That is, the first single-hook 34 and the second single-hook 35 are connected to the connection member 33 with a mirror symmetric positional relationship with respect to the imaginary line V₁ extending in the upward-downward direction through the central shaft 32.

In addition, each of the first single-hook 34 and the second single-hook 35 can be independently rotated around an axis extending in the forward-rearward direction (that is, an extension direction of each of the first shaft 33a and the second shaft 33b). Meanwhile, each of the first single-hook 34 and the second single-hook 35 cannot rotate independently around an axis extending in the upward-downward direction. Therefore, it is not necessary to interpose thrust bearings between the connection member 33 and the first single-hook 34 and between the connection member 33 and the second single-hook 35.

Moreover, the central shaft 32 is connected to the connection member 33 so as to be relatively rotatable around an axis extending in the forward-rearward direction (that is, an extending direction of the third shaft 33c). Meanwhile, the central shaft 32 cannot rotate around an axis extending in the upward-downward direction with respect to the connection member 33. Furthermore, the central shaft 32 is supported by the thrust bearing 31b of the sheave block 31 in a state of being rotatable about an axis extending in the upward-downward direction. That is, the central shaft 32, the connection member 33, the first single-hook 34, and the second single-hook 35 cannot rotate independently and can integrally rotate around the axis extending in the upward-downward direction.

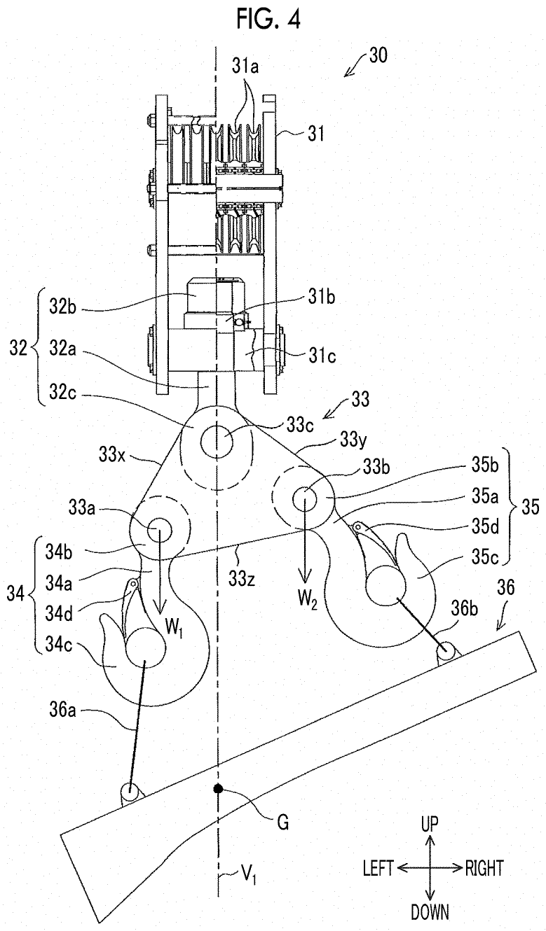

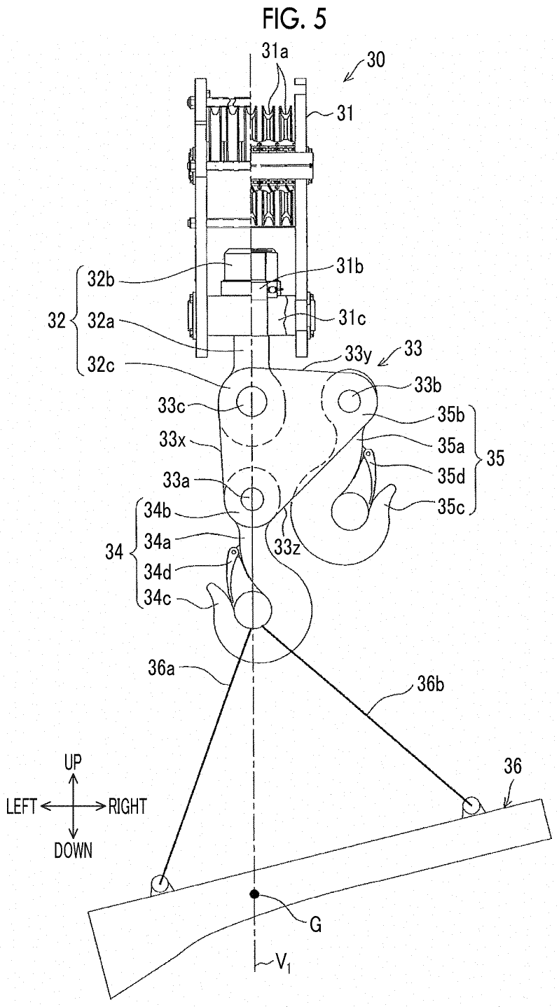

Next, a movement in a case where a long cargo 36 is hung on the hook block 30 will be described with reference to FIGS. 4 and 5. FIG. 4 is a view showing a state where the cargo 36 is hung on both the first single-hook 34 and the second single-hook 35. FIG. 5 is a view showing a state where the cargo 36 is hung on only the first single-hook 34.

First, as shown in FIG. 4, a case is considered, in which a wire 36a attached at a position shifted from a center of gravity G of the long cargo 36 extending in the right-left direction to one side (left side) is hooked to the locking portion 34c of the first single-hook 34, and a wire 36b attached at a position shifted from the center of gravity G of the cargo 36 to the other side (right side) is hooked to the locking portion 35c of the second single-hook 35. In this case, if lengths of the wires 36a and 36b are not set appropriately, the load W₁ applied to the first single-hook 34 is larger than the load W₂ applied to the second single-hook 35 (that is, the center of gravity G of the cargo 36 is localized on the first single-hook 34 side from immediately below the central shaft 32).

In this case, each of the central shaft 32, the connection member 33, the first single-hook 34, and the second single-hook 35 relatively rotates on a virtual plane including the upward-downward direction and the right-left direction such that the center of gravity G of the cargo 36 moves to immediately below the central shaft 32. In other words, each of the central shaft 32, the connection member 33, the first single-hook 34, and the second single-hook 35 rotates around the axis extending in the forward-rearward direction such that the center of gravity G of the cargo 36 is positioned on the imaginary line V₁.

More specifically, the connection member 33 rotates with respect to the central shaft 32 about the third shaft 33c such that the first single-hook 34 is positioned below the second single-hook 35 (in the counterclockwise direction in FIG. 4). In addition, the first single-hook 34 and the second single-hook 35 rotate with respect to the connection member 33 about the first shaft 33a and the second shaft 33b in a direction (the clockwise direction in FIG. 4) opposite to the rotation direction of the connection member 33 so as to maintain a posture (a posture shown in FIG. 2) before the cargo 36 is hung.

Next, as shown in FIG. 5, if both the wires 36a and 36b are hooked to the locking portion 34c of the first single-hook 34, a difference between the weight W₁ applied to the first single-hook 34 and the weight W₂ applied to the second single-hook 35 is maximized. In this case, the rotation directions of the connection member 33, the first single-hook 34, and the second single-hook 35 are the same as those in the case of FIG. 4, and each rotation amount (rotation angle) is larger than that in the case of FIG. 4.

More specifically, the connection member 33 rotates with respect to the central shaft 32 until the centers of the first shaft 33a and the third shaft 33c are aligned with each other in the upward-downward direction. In addition, the hook block 30 according to the present embodiment is configured to satisfy the following relationship in the state where the connection member 33 is largely inclined as described above.

First, the first single-hook 34 and the second single-hook 35 do not come into contact with each other. That is, the first single-hook 34 and the second single-hook 35 are connected to the connection member 33 with a positional relationship in which the first single-hook 34 and the second single-hook 35 do not contact with each other regardless of the rotation angle of the connection member 33. In other words, the first single-hook 34 and the second single-hook 35 are separated from each other in the right-left direction regardless of the rotation angle of the connection member 33.

In addition, a portion of the second single-hook 35 enters between the pair of support plates 33f and 33g. That is, the second single-hook 35 does not come into contact with the pair of support plates 33f and 33g regardless of the rotation angle of the connection member 33. Furthermore, the second side 33y of the pair of support plates 33f and 33g is approximately parallel to an imaginary line extending in the right-left direction through the center of the third shaft 33c. That is, the connection member 33 does not come into contact with the sheave block 31 regardless of the rotation angle of the connection member 33.

The crawler crane 1 has the above-described configuration, and thus, for example, the following operation and effect are exerted.

In a case where the long cargo 36 is lifted by the hook block 30 according to the present embodiment, the cargo 36 is locked to the locking portions 34c and 35c in a state where a longitudinal direction of the cargo 36 faces the right-left direction. In this case, as shown in FIG. 4, the connection member 33, the first single-hook 34, and the second single-hook 35 rotate around the axis extending in the forward-rearward direction, and thus, the center of gravity G of the cargo 36 is disposed immediately below the central shaft 32. That is, even in a case where an inexperienced on-hook technician works or is forced to work in a time-limited environment, it is possible to avoid an inconvenience caused by the position of the center of gravity G of the cargo 36 being shifted from the imaginary line V₁.

In addition, according to the present embodiment, since the first single-hook 34 and the second single-hook 35 cannot rotate around the axis extending in the upward-downward direction, and thus, it is not necessary to interpose a thrust bearing between the first single-hook 34 and the second single-hook 35, and the connection member 33. As a result, as compared to the hook block having the thrust bearing described in the related art, it is possible to shorten an entire length of the hook block 30 in the upward-downward direction. That is, if this hook block 30 is mounted, a work near a limit height of the crawler crane 1 is possible.

Further, in the hook block 30 according to the present embodiment, if the locking portions 34c and 35c face the inside and are attached to the connection member 33, it is necessary for a worker to put hands into a portion between the first single-hook 34 and the second single-hook 35 so as to perform the hooking. Therefore, as shown in FIG. 2, the first single-hook 34 and the second single-hook 35 are attached such that the locking portions 34c and 35c face outward, and thus, it is possible to improve safety and efficiency of a hooking operation.

Moreover, according to the present embodiment, as shown in FIG. 4, in the case where the connection member 33 is inclined with respect to the central shaft 32, each of the first single-hook 34 and the second single-hook 35 rotates with respect to the connection member 33. Thereby, regardless of the rotation angle of the connection member 33, the first single-hook 34 and the second single-hook 35 can maintain original postures thereof. As a result, it is possible to efficiently perform the hooking operation even in the state where the connection member 33 is inclined. However, the first single-hook 34 and the second single-hook 35 may be independently unrotatable around the axis extending in the forward-rearward direction.

In addition, as shown in FIG. 5, the hook block 30 according to the present embodiment is configured and disposed such that the first single-hook 34 and the second single-hook 35 do not come into contact with each other and the second single-hook 35 and the connection member 33 do not come into contact with each other regardless of the rotation angle of the connection member 33. As a result, it is possible to reduce a possibility of a damage of each component, breakage of the hooked wire, or the like due to collision.

In addition, the hook block 30 according to the present embodiment is configured and disposed such that the connection member 33 and the sheave block 31 do not come into contact with each other regardless of the rotation angle of the connection member 33. Therefore, it is possible to shorten a length of the central shaft 32. As a result, if this hook block 30 is mounted, a work near a limit height of the crawler crane 1 is possible.

### Modification Example

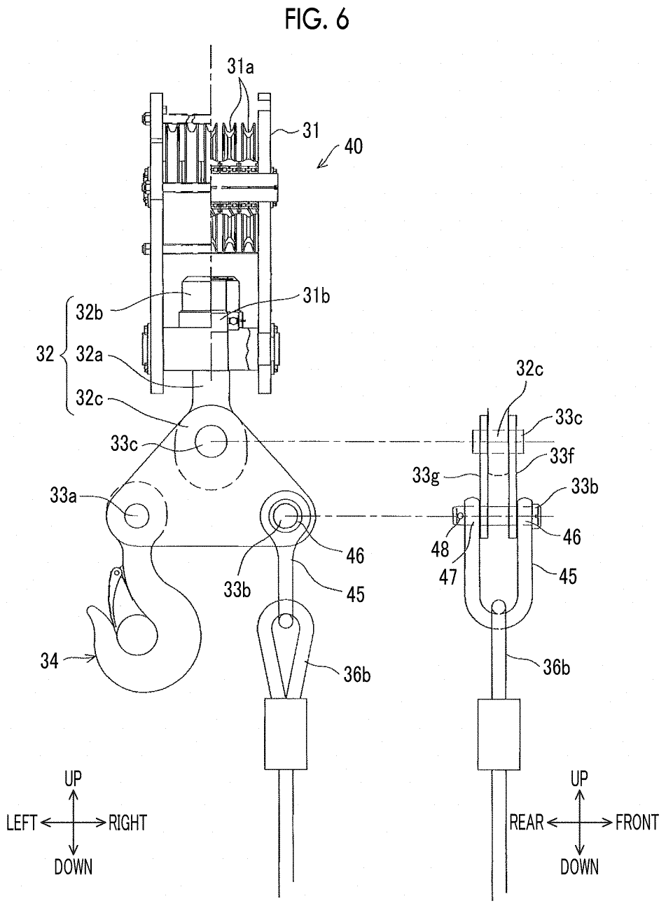

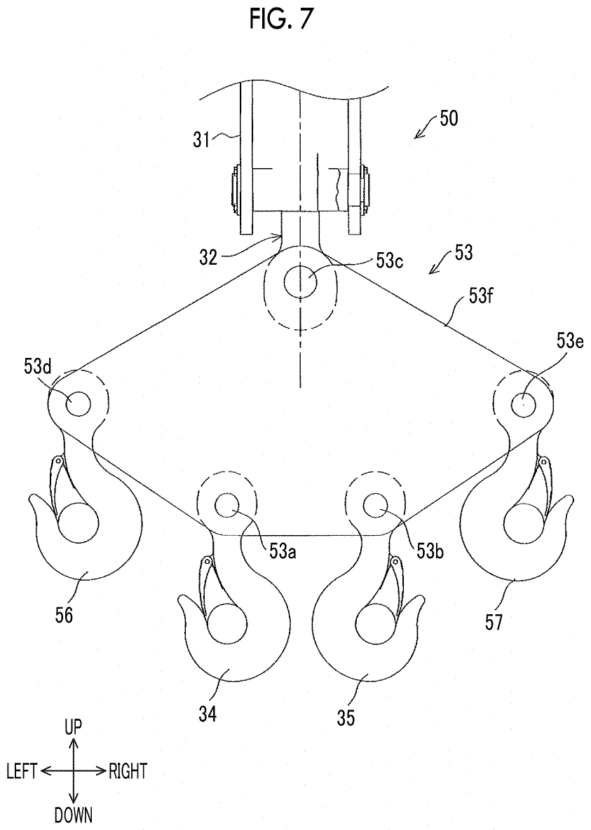

The hook block according to the present invention is not limited to the configuration shown in FIGS. 1 to 5. Hereinafter, hook blocks 40 and 50 according to modification examples will be described with reference to FIGS. 6 and 7. FIG. 6 is a front view and a side view of the hook block 40, and FIG. 7 is a front view of the hook block 50. Moreover, detail descriptions of common points between the hook block 30 and the hook blocks 40 and 50 will be omitted, and differences therebetween will be mainly described.

First, the hook block 40 shown in FIG. 6 includes the sheave block 31, the central shaft 32, the connection member 33, the first single-hook 34, and a shackle 41. That is, the hook block 40 is different from the hook block 30 in that the shackle 41 is provided instead of the second single-hook 35, and other points are the same as those of the hook block 30. In this way, members supported by the first shaft 33a and the second shaft 33b of the connection member 33 may be the same shape as each other or may have shapes different from each other.

The shackle 45 has a U-shaped appearance. In addition, an inside of the U shape functions as a locking portion for locking the wire 36b. That is, the shape of the locking portion is not limited to the locking portions 34c and 35c. In addition, a pair of through-holes 46 and 47 penetrating the shackle 45 in the forward-rearward direction is formed on both end portions of the shackle 45.

As shown in FIG. 6, the pair of support plates 33f and 33g is held by both end portions of the shackle 45, the second shaft 33b penetrating the support plates 33f and 33g is inserted into the through-holes 46 and 47 and is prevented from coming out by a spilt pin 48 or the like. Accordingly, the shackle 45 is connected to the connection member 33 in a state where the shackle 45 cannot rotate around the axis extending in the upward-downward direction and can rotate around the axis extending in the forward-rearward direction.

Next, the hook block 50 shown in FIG. 7 includes the sheave block 31, the central shaft 32, a connection member 53, the first single-hook 34, the second single-hook 35, a third single-hook 56, and a fourth single-hook 57. That is, compared to the hook block 30, in the hook block 50, a shape of the connection member 53 is different and the third single-hook 56 and the fourth single-hook 57 are provided. Other points are the same as those of the hook block 30. In this way, the number of single-hooks supported by the connection member 53 may be two or more.

The connection member 53 includes a first shaft 53a, a second shaft 53b, a third shaft 53c, a fourth shaft 53d, and a fifth shaft 53e which respectively extend in the forward-rearward direction, and a pair of support plates 53f and 53g (the support plate 53g is not shown) which supports the first shaft 53a, the second shaft 53b, the third shaft 53c, the fourth shaft 53d, and the fifth shaft 53e.

The first shaft 53a, the second shaft 53b, the fourth shaft 53d, and the fifth shaft 53e are disposed to be separated from each other in the right-left direction. In addition, the third shaft 53c is disposed between the first shaft 53a and the fourth shaft 53d, and the second shaft 53b and the fifth shaft 53e in the right-left direction. In other words, the first shaft 53a and the fourth shaft 53d, and the second shaft 53b and the fifth shaft 53e are disposed on sides opposite to each other such that the third shaft 53c is interposed therebetween, in the right-left direction.

When viewed in the forward-rearward direction, each of the pair of support plates 53f and 53g has an approximately fans-shaped appearance. In addition, the third shaft 53c is disposed at a main position of the fan shape, and the first shaft 53a, the second shaft 53b, the fourth shaft 53d, and the fifth shaft 53e are disposed along an arc. That is, the shape of the connection member is not limited to the example of FIG. 2.

### Other Modification Examples

First, the number of the connection members is not limited to one. As another example, a second connection member (not shown) may be connected to the first shaft 33a of the connection member 33 (first connection member) of FIG. 2. In addition, single-hooks may be respectively connected to the second shaft 33b of the first connection member 33, and the first shaft and the second shaft of the second connection member. That is, a plurality of connection members may be disposed in series.

In addition, the shape of the connection member is not limited to the examples of FIGS. 2 and 7. As another example, the connection member may be an elongated rod extending in the right-left direction. In addition, in the right-left direction, the third shaft may be disposed at a center, and the first shaft and the second shaft may be disposed at symmetrical positions such that the third shaft is interposed therebetween.

Moreover, the connection member 33, the first single-hook 34, and the second single-hook 35 may be integrally formed with each other. That is, in a state where the locking portions 34c and 35c cannot rotate independently around an axis extending in the upward-downward direction and can integrally rotate around the axis extending in the forward-rearward direction, the locking portions 34c and 35c may be connected to the central shaft 32. That is, for example, the “locking portions 34c and 35c being connected to the central shaft 32” includes both an indirect connection case where the locking portions 34c and 35c are connected to the central shaft 32 via the connection member 33 as described in the embodiment, and a direct connection case where a member obtained by integrally forming the connection member 33, the first single-hook 34, and the second single-hook 35 is connected to the central shaft 32.

In addition, a specific example of the crane is not limited to the crawler crane 1, and may be a wheel crane, a rough terrain crane, an all-terrain crane, or the like. In addition, each of the hook blocks 30, 40, and 50 can be applied not only to a mobile crane having a traveling body but also to a ceiling crane or the like.

It should be understood that the invention is not limited to the above-described embodiment, but may be modified into various forms on the basis of the spirit of the invention. Additionally, the modifications are included in the scope of the invention.

What is claimed is:

1. A hook device comprising:
a central shaft which extends in a first direction; and
a first locking portion and a second locking portion which are disposed such that the central shaft is interposed therebetween, in a second direction orthogonal to the first direction,
wherein the first locking portion and the second locking portion are connected to the central shaft in a state where the first locking portion and the second locking portion are not rotatable independently around an axis extending in the first direction and are rotatable around an axis extending in a third direction different from the first direction and the second direction.

2. The hook device according to claim 1, further comprising:
a first single-hook having the first locking portion;
a second single-hook having the second locking portion; and
a connection member which is connected to each of the first single-hook, the second single-hook, and the central shaft,
wherein the first single-hook and the second single-hook are connected to the connection member in a state where each of the first single-hook and the second single-hook is not rotatable around the axis extending in the first direction, at positions separated from each other in the second direction, and
wherein the central shaft is connected to the connection member in a state where the central shaft relatively is rotatable around the axis extending in the third direction, between the first single-hook and the second single-hook in the second direction.

3. The hook device according to claim 2,
wherein the first single-hook and the second single-hook are connected to the connection member such that the first locking portion and the second locking portion face outward.

4. The hook device according to claim 2,
wherein each of the first single-hook and the second single-hook is connected to the connection member in a state where the first single-hook and the second single-hook are rotatable independently around the axis extending in the third direction.

5. The hook device according to claim 2,
wherein the connection member includes
a first shaft which extends in the third direction and rotatably supports one end of the first single-hook,
a second shaft which extends in the third direction at a position separated from the first shaft in the second direction and rotatably supports one end of the second single-hook, and
a third shaft which extends in the third direction between the first shaft and the second shaft in the second direction and rotatably supports one end of the central shaft, and
a pair of support plates which supports both ends of each of the first shaft, the second shaft, and the third shaft, and
wherein in the third direction, a separation distance between the pair of support plates is larger than a thickness of each of the first single-hook and the second single-hook.

6. The hook device according to claim 5,
wherein the first single-hook and the second single-hook are connected to the connection member with a positional relationship in which the first single-hook and the second single-hook do not come into contact with each other in a state where the connection member is inclined until the first shaft and the third shaft are aligned with each other in the first direction.

7. The hook device according to claim 2,
wherein the first single-hook and the second single-hook are connected to the connection member with a mirror symmetric positional relationship with respect to an imaginary line extending in the first direction through the central shaft.

8. The hook device according to claim 5, further comprising:
a sheave block which supports the other end of the central shaft in a state of being rotatable around the axis extending in the first direction,
wherein the connection member is configured so as not to come into contact with the sheave block in a state where the connection member is inclined until the first shaft and the third shaft are aligned with each other in the first direction.

9. The hook device according to claim 8,
wherein an appearance of the connection member when viewed in the third direction has a shape in which an angle between a first side along an imaginary line connecting the first shaft and the third shaft to each other and a second side along an imaginary line connecting the second shaft and the third shaft to each other is 90° or less.

10. A crane comprising:
the hook device according to claim 1.
